(19) United States
(12) Patent Application Publication
(10) Pub. No.: US 2006/0132415 A1
(43) Pub. Date: Jun. 22, 2006

(54) Liquid crystal display and the driving method thereof

(76) Inventor: Hui-Lung Yu, Sindian City (TW)

Correspondence Address: RABIN & Berdo, PC, 1101 14TH STREET, NW, SUITE 500, WASHINGTON, DC, 20005, US

(21) Appl. No.: 11/168,530

(22) Filed: Jun. 29, 2005

(30) Foreign Application Priority Data
Dec. 17, 2004 (TW) 93139571

(51) Int. Cl. G09G 3/36

(52) U.S. Cl. 345/98

(57) ABSTRACT

A liquid crystal display (LCD) includes a display panel, an adjusting circuit, and a driving circuit. The display panel includes a common electrode. The adjusting circuit is electrically connected with the common electrode. According to the voltage distribution on the common electrode, the adjusting circuit outputs a distribution parameter. The driving circuit receives the distribution parameter and drives the display panel according to the distribution parameter. The adjusting circuit further includes a voltage comparator and a compensating circuit. The voltage comparator is used for measuring the voltage difference between two terminals of the common electrode. The compensating circuit is for obtaining the distribution parameter according to the voltage difference

This application claims the benefit of Taiwan application Serial No. 93139571, filed Dec. 17, 2004, the subject matter of which is incorporated herein by reference.

### BACKGROUND OF THE INVENTION

1. Field of the Invention

The invention relates in general to a liquid crystal display and the display method thereof, and more particularly to a liquid crystal display and the display method thereof for compensating the voltage shift on the common electrode.

2. Description of the Related Art

Ordinary liquid crystal display panel has a common electrode, a pixel electrode and a liquid crystal foil positioned between the common electrode and the pixel electrode. By applying the common electrode voltage to the common electrode and applying the pixel voltage to the pixel electrode, the voltage difference between the common electrode and the pixel electrode can be used to change the photo penetration rate of the liquid crystal foil.

The photo penetration rate of the liquid crystal foil has much to do with the voltage difference between the common electrode and the pixel electrode, but is irreverent to the polarity of the voltage difference. If voltages of the same polarity are continually applied to the liquid crystal foil, a flat image problem might easily occur. Normally, polarity inversion method is used to avoid the above problem. Referring to FIG. 1, a curve illustrating the relationship between the pixel voltage V and the photo penetration rate I of liquid crystal molecules is shown. The positive pixel voltage Vp and the negative pixel voltage Vn which are symmetric to the voltage level Vcom of the common electrode can achieve the same photo penetration rate Ix. Therefore, the flat image problem can be avoided by alternating the polarities of the voltages to drive the liquid crystal foil.

However, the common electrode still has impedance, which prevents the common electrode voltages of respective points on the common electrode from remaining at the same voltage level Vcom of the common electrode. Therefore, the positive and the negative pixel voltage of the pixel electrode, the above mentioned Vp and Vn for example, would not generate the same voltage difference on the liquid crystal foil. This will cause the actual voltage difference between the common electrode and the pixel electrode to differ with a predetermined target of voltage difference, resulting in problems of flicker, image flatness and deteriorated display quality.

### SUMMARY OF THE INVENTION

It is therefore an object of the invention to provide a liquid crystal display and the display method thereof to resolve the problem arising due to the decay in common electrode voltage during display process.

According to an object of the invention, a display method of liquid crystal display is provided. The liquid crystal display comprises a display panel and a driving circuit. The display panel has a common electrode. The display method is disclosed below. A distribution parameter is outputted according to the voltage distribution on the common electrode. The driving circuit drives the display panel according to distribution parameter. In the step of outputting the distribution parameter, a voltage difference between two terminals of the common electrode is measured and used for obtaining distribution parameter.

According to another object of the invention, a liquid crystal display comprising a display panel, an adjusting circuit and a driving circuit is provided. The display panel has a common electrode. The adjusting circuit is electrically connected with the common electrode and outputs a distribution parameter according to the voltage distribution of a common electrode voltage on the common electrode. The driving circuit receives the distribution parameter and drives the display panel according to the received distribution parameter. The adjusting circuit further comprises a voltage comparator and a compensating circuit. The voltage comparator is used for measuring the voltage difference between two terminals of the common electrode. The compensating circuit is used for obtaining distribution parameter according to the voltage difference.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a curve illustrating the relationship between the pixel voltage V and the photo penetration rate I of liquid crystal molecules;

FIG. 2 is a flowchart of a display method of the liquid crystal display according to a preferred embodiment of the invention;

FIG. 3 is a block diagram of the liquid crystal display according to a preferred embodiment of the invention;

FIG. 4 is a diagram illustrating the relationship between the positive/negative pixel voltage and the voltage level of the common electrode;

FIG. 5 is a diagram of the voltage distribution of the common electrode voltage on the common electrode;

FIG. 6 is a block diagram of the liquid crystal display according to another preferred embodiment of the invention;

FIG. 7 is a relationship curve illustrating the relationship between the pixel voltage and the gray level value.

### DETAILED DESCRIPTION OF THE INVENTION

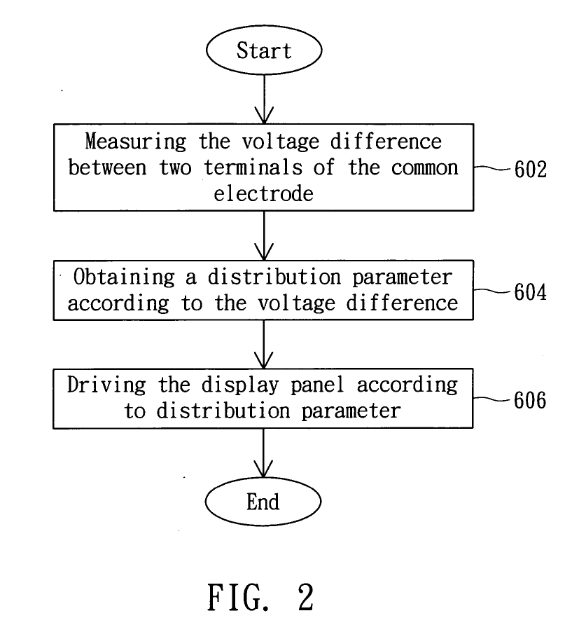

Referring to FIG. 2, a flowchart of a display method of the liquid crystal display according to a preferred embodiment of the invention is shown. At first, the method begins at step 602: the voltage difference between two terminals of the common electrode is measured. Next, proceed to step 604: a distribution parameter is obtained according to the voltage difference. Lastly, proceed to step 606: drive the display panel according to distribution parameter. Moreover, the driving circuit of the liquid crystal display adjusts the gray level value and drives the liquid crystal display panel according to distribution parameter. When the driving circuit has a plurality of drive chips, each of the drive chips can adjust the gray level value according to the distribution parameter to compensate the decay in the common electrode voltage. Alternatively, since each of the drive chips respectively corresponds to a set of Gamma voltages, the driving circuit can adjust the sets of Gamma voltages according to the distribution parameter without changing their gray level values so that each of the drive chip can drive the display panel to compensate the decay in the common electrode voltage according to the adjusted Gamma voltage. Therefore, the problems arising due to the decay in common electrode voltage during display process can be resolved by adjusting the gray level value or the Gamma voltage.

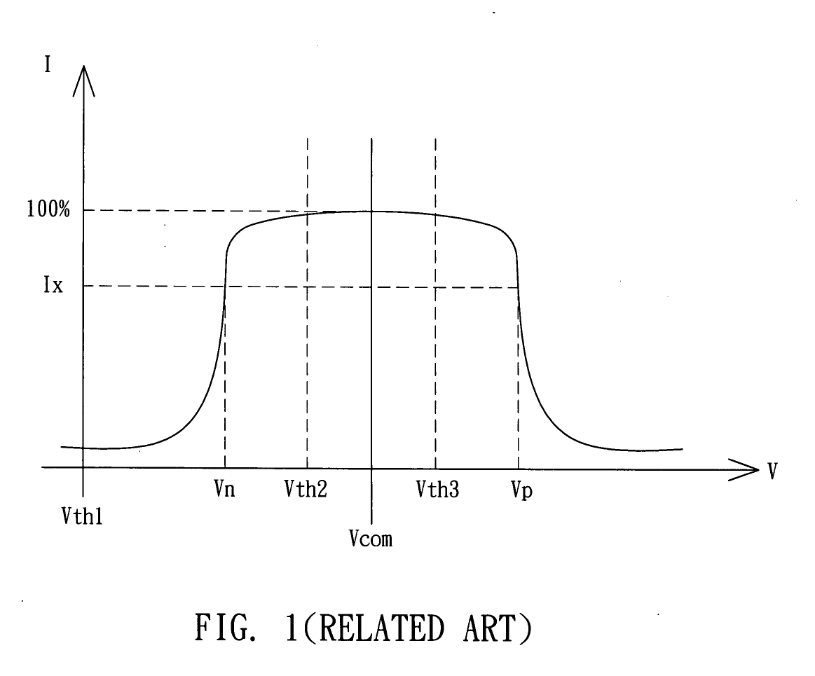

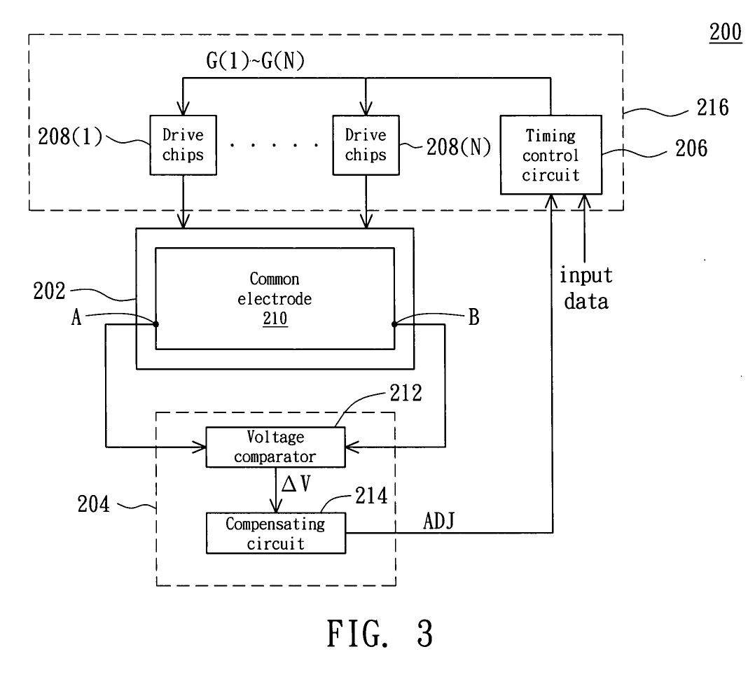

Referring to FIG. 3, a block diagram of the liquid crystal display according to a preferred embodiment of the invention is shown. Liquid crystal display 200 comprises a liquid crystal display panel 202, an adjusting circuit 204 and a driving circuit 216. The liquid crystal display panel 202 has a common electrode 210. The adjusting circuit 204 comprises a voltage comparator 212 and a compensating circuit 214. The voltage comparator 212 is electrically connected with the common electrode 210 for measuring a voltage difference ΔV between two terminals of the common electrode 210 such as point A and point B. The compensating circuit 214 outputs a distribution parameter ADJ according to the voltage difference ΔV. The driving circuit 216 further comprises a timing control circuit 206 and a plurality of drive chips 208(1)˜208(N). The timing control circuit 206 receives a pixel data and generates a plurality of gray level values G(1)˜G(N) according to the distribution parameter ADJ. Each of the drive chip 208(1)˜208(N) respectively corresponds to a set of Gamma voltages. Each set of Gamma voltages represents a Gamma curve. For example, the drive chip 208(1) generates a corresponding pixel voltage to drive the liquid crystal display panel 202 according to a received gray level value G(1) and corresponding Gamma curve (not shown in FIG. 3) such as the Gamma curve of FIG. 1.

Suppose the pixel corresponding to point A positioned on the common electrode 210 is P(A) (not shown in FIG. 3) and the pixel corresponding to point B is P (B) (shown in FIG. 3). Conventionally, for the pixels P(A) and P(B) to display with the same luminance, which corresponds to a particular gray level value GX, the corresponding drive chips such as drive chips 208(1) and 208(N) would have to drive the pixels P(A) and P(B) to generate the same luminance according to the gray level value GX. That is, both the pixels P(A) and P(B) are driven by the same pixel voltage (positive pixel voltage Vp(GX) and negative pixel voltage Vn(GX)), so that the pixels P(A) and P(B) can display the same luminance.

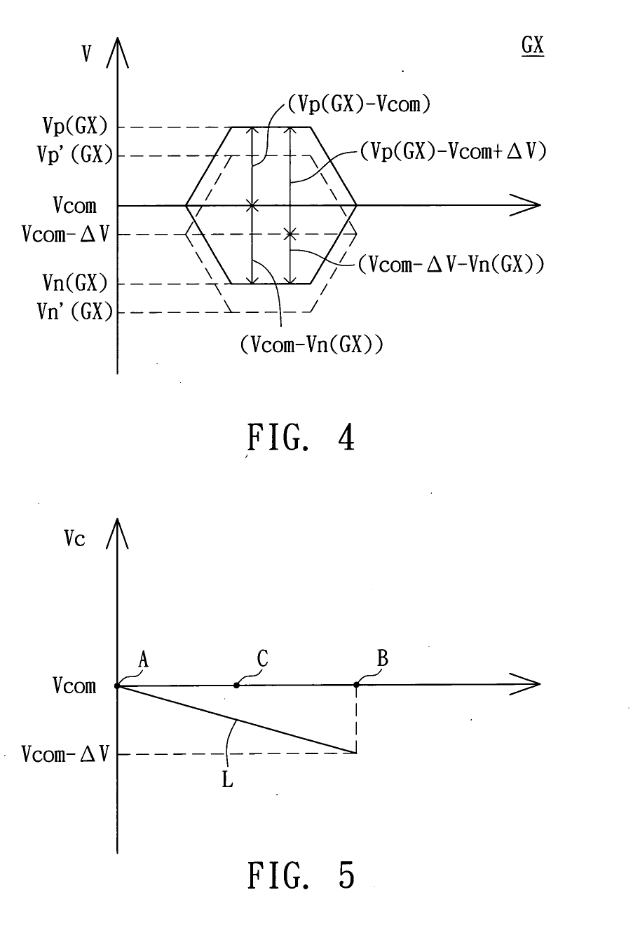

Referring to FIG. 4, a diagram illustrating the relationship between the positive/negative pixel voltage and the voltage level of the common electrode is shown. Since the two terminals of the common electrode 210 have the voltage difference ΔV, the corresponding common electrode voltage of the pixel P(A) is the voltage level Vcom of the common electrode, while the corresponding common electrode voltage of the pixel P(B) is obtained by having the voltage level Vcom of the common electrode subtracted by the voltage difference ΔV, i.e. Vcom-ΔV. Since the absolute value of positive voltage difference (Vp-(GX)-Vcom) of the pixel P (A) is the same with that of the negative voltage difference (Vcom-Vn (GX)), the positive voltage Vp (GX) and the negative voltage Vn (GX) would have the same photo penetration rate at the pixel P(A).

If the same positive pixel voltage Vp(GX) is applied to the pixel P(B), the positive voltage difference of the pixel P(B) would be (Vp(GX) −Vcom+ΔV), i.e. ΔV higher than the positive voltage difference of the pixel P(A), causing the pixel P(B) to be brighter than the pixel P(A). If a negative pixel voltage Vn (GX) is applied to the pixel P(B), the negative voltage difference would be (Vcom −×V−Vn (GX)), i.e. ΔV lower than the negative voltage difference of the pixel P(A), causing the pixel P(B) to be darker than the pixel P(A). Consequently, flicker and image flatness would occur during polarity inversion.

The spirit of the embodiment of the invention lies in adjusting the corresponding pixel voltage of each pixel on the display panel according to the voltage distribution of the common electrode voltage on the common electrode 210. That is, the positive voltage difference of the pixel P(B) and the negative voltage difference of the pixel P(B) are adjusted to be the same. As shown in FIG. 4, the positive pixel voltage of the pixel P(B) is adjusted to be Vp′(GX)=(Vp(GX)−ΔAV) while the negative pixel voltage is adjusted to be Vn′(GX)=(Vn(GX)−ΔAV), so that the positive voltage difference of the pixel P(B) becomes the same with the negative voltage difference of the pixel P(B) and that the problems arising due to the decay in common electrode voltage during display process can be resolved.

Moreover, Referring to FIG. 5, a diagram of the voltage distribution of the common electrode voltage on the common electrode is shown, wherein the y-axis is the common electrode voltage measured in volt V, while the x-axis is the position of respective points on the common electrode 210. The common electrode voltage measured at point A of the common electrode 210 is the voltage level of the common electrode Vcom, while the common electrode voltage measured at another terminal, i.e. point B, is (Vcom−ΔV). Therefore the corresponding common electrode voltage (X) of any point X positioned between point A and point B can be estimated according to the slope L:

The common electrode voltage (X)=Vcom−ΔAV*D(X,A)/D (B,A) (1), wherein D is a distance function, D(X, A) denotes the distance from X to A, D (B, A) denotes the distance from B to A. For example, point C is positioned at the middle between point A and point B, so the common electrode voltage of point C is (Vcom−ΔV/2). A voltage comparator 212 is used for measuring the voltage difference ΔV between the two terminals of the common electrode 210 wherein the two terminals are point A and point B for instance, then the compensating circuit 214 is used for obtaining the rate of horizontal change in the common electrode voltage of the common electrode 210 according to the voltage difference ΔV, and the shift in the common electrode voltage of respective point, i.e. the distribution parameter ADJ, is obtained according to the slope. In the present embodiment, only horizontal change in voltage of the common electrode 210 is measured, as for the vertical change in voltage, which is too little to be considered, is assumed to be 0 and neglected. However, according to the spirit of the invention, both the horizontal and the vertical change in voltage can be included and the application is not repeated here.

Therefore, after the shifts in the common electrode voltage of respective points are obtained, the shifts can be compensated so that the positive voltage difference of the pixel P (B) and the negative voltage difference of the pixel P (B) are still the same under the circumstance when shift occurs to the common electrode voltage of the pixel P (B). Therefore, the shift in the common electrode voltage on the common electrode 210 can be compensated by adjusting the gray level value G outputted from the timing control circuit 206.

The compensation method using the gray level value is further exemplified below. The display panel 202 of the present embodiment is exemplified by the maximum luminance which occurs when the voltage difference between the pixel voltage for driving the pixel and the common electrode is 0. The positive pixel voltage of the pixel P(B) has to be Vp′(GX)=(Vp(GX)−ΔAV) whose value is smaller than Vp(GX), so the corresponding gray level value GX of the pixel P(B) should be increased to (GX+Δg), wherein Δg is determined in response to the voltage difference ΔV. Besides, the negative pixel voltage of the pixel P(B) has to be Vn′(GX)=(Vn(GX)−ΔV) whose absolute value is larger than Vn(GX), so the corresponding gray level value GX of the pixel P(B) should be reduced to (GX−Δg). In response to the pixel P(B), the timing control circuit 206 outputs various gray level values (GX+Δg) and (GX−Δg) according to whether the voltage difference ΔV between point A and point B is at positive polarity or negative polarity, so that the positive and the negative pixel voltages Vp′(GX) and Vn′(GX) of the adjusted pixel P(B) are symmetric to the shifted common electrode voltage and are equal to Vcom−ΔV for the pixel P(B)and the pixel P(A) to display with the same luminance.

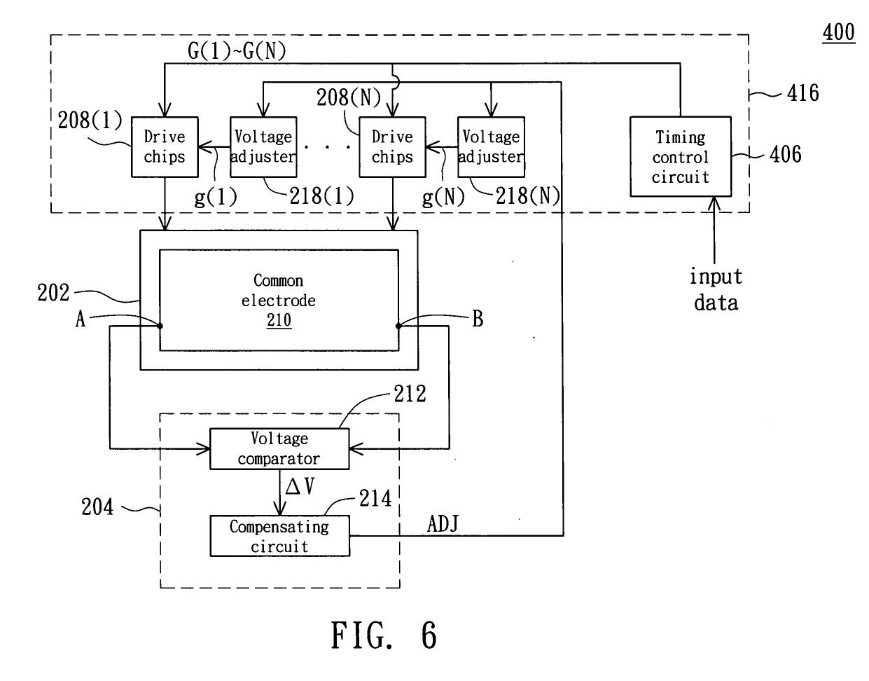

The compensation method using the Gamma curve is exemplified below. Referring to FIG. 6, a block diagram of the liquid crystal display according to another preferred embodiment of the invention is shown. Liquid crystal display 400 comprises a display panel 202, an adjusting circuit 404 and a driving circuit 416. The display panel 202 has a common electrode 210. The adjusting circuit 204 comprises a voltage comparator 412 and a compensating circuit 414. The voltage comparator 412 is electrically connected with the common electrode 210 for measuring the voltage difference AV between the two terminals of the common electrode 210, wherein the two terminals are point A and point B for instance. The compensating circuit 414 outputs a distribution parameter ADJ′ according to the voltage difference ΔV. The driving circuit 416 further comprises a timing control circuit 406, a plurality of drive chips 208(1)˜208(N) and a plurality of voltage adjusters 218(1)˜218(N). Each of the drive chips 208(1)˜218(N) receives a set of Gamma voltages, and one set of Gamma voltages containing several Gamma voltage. The N sets of Gamma voltages are generated according to the distribution parameter, so that the N sets of Gamma voltages are preferably differ from each other. The N set of Gamma voltages are corresponding to Gamma curves g(1)˜g(N) respectively. The drive chips 208(1)˜218(N) output the pixel voltage according to the corresponding Gamma curves g(1)˜g(N) and the corresponding gray level values G(1)˜G(N). By changing the Gamma voltage received by each of the drive chips 208(1)˜208(N), the pixel voltage would be changed accordingly to compensate the shift in the common electrode voltage without adjusting the gray level values G(1)˜G(N). Therefore, the compensating method using Gamma voltage is applicable to the liquid crystal display 400 having a plurality of drive chips 208(1)˜208(N). Each of the drive chips 208(1)˜208(N) respectively drives a plurality of data lines. For example, the drive chip 208(1), which drives a first region of the display panel 202, comprises data lines 1˜384 (not shown in FIG. 6). The drive chip 208(2), which drives a second region of the display panel 202, comprises data lines 385˜769 (not shown in FIG. 6) for instance. By the same token, each of the drive chips 208 drives a respective region whose shift in the common electrode voltage can be obtained from the average value of the shifts in the common electrode voltage within the respective region.

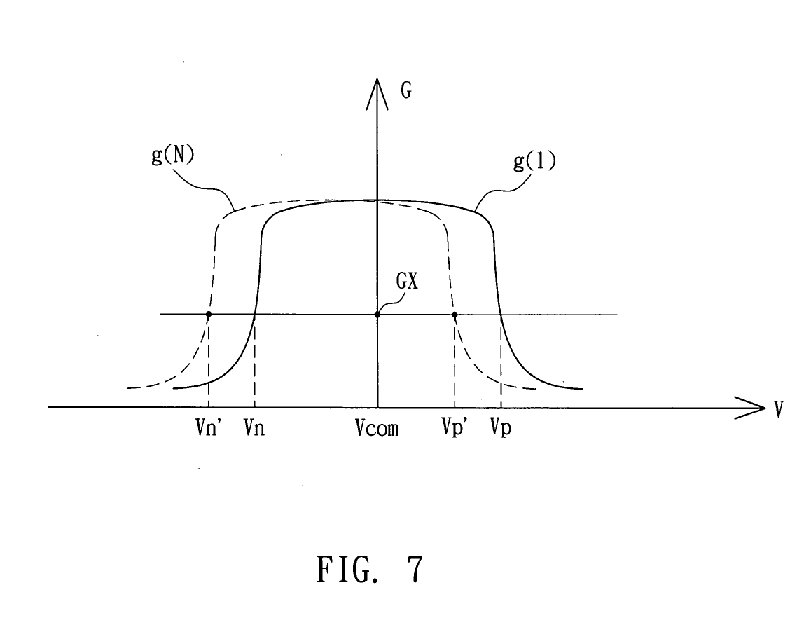

Referring to FIG. 7, a relationship curve illustrating the relationship between the pixel voltage and the gray level value is shown, wherein the y-axis denotes the gray level value G, while the x-axis denotes the pixel voltage which is measured in volt V. Take the Gamma curve g(1) for example. The Gamma curve g(1) is the curve before adjusting and is symmetric to the voltage level Vcom of the common electrode. The present example is applicable to the first region, i.e. the region where point A belongs to, and the average value of the shifts in the common electrode voltage within the region is assumed to be 0. When the gray level value G is assumed to be GX, the positive pixel voltage of the pixel P (A) is Vp (GX), while the negative pixel voltage is Vn (GX). The Gamma curve g (N) is applicable to the N^{th} region, a region of the pixel P (B) for instance, wherein the average value of the shifts in the common electrode voltage within the region is assumed to be ΔV′. When the gray level value G is GX, the voltage comparator 212 obtains the adjusting parameter ADJ′ via the ΔV calculated by the compensating circuit 214 according to the voltage difference ΔV between the two terminals (A, B). Then the voltage adjuster 218(N) outputs a set of compensated Gamma voltages according to the adjusting parameter ADJ′ as the Gamma curve g(N) so as to compensate the positive pixel voltage of the pixel P(B) which is Vp′=Vp−ΔV′ and the negative pixel voltage which is Vn′=Vn−ΔV′, so that the positive and the negative voltages Vp′ and Vn′ of the pixel P(B) still can be symmetric to the shifted common electrode voltage.

The liquid crystal display and the display method thereof disclosed in above embodiments of the invention obtains a distribution parameter via the voltage difference of the common electrode voltage on the common electrode and performs compensation using the gray level value or the Gamma curve according to the distribution parameter. By doing so, the adjustment of the pixel voltage is obtained according to various shifts in the common voltage at various positions of the display panel to compensate the shift in the common electrode voltage. So, the invention is capable of improving the problem of having flicker or flat image on the liquid crystal screen.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving device for a display panel having a common electrode, comprising:
an adjusting circuit, electrically connected with the common electrode, for providing a distribution parameter according to the voltage distribution of a common electrode voltage of the common electrode; and
a driving circuit for driving the display panel in accordance with the distribution parameter.

2. The liquid crystal display according to claim 1, wherein the adjusting circuit comprises:
a voltage comparator for measuring a voltage difference between two terminals of the common electrode; and
a compensating circuit for obtaining the distribution parameter according to the voltage difference.

3. The liquid crystal display according to claim 1, wherein the driving circuit is for adjusting a plurality of gray level values according to the distribution parameter and to drive the liquid crystal display panel according to the gray level values.

4. The liquid crystal display according to claim 1, wherein the driving circuit comprises a plurality of drive chips, each of the drive chips receives one set of Gamma voltages, and the sets of Gamma voltages are generated according to the distribution parameter.

5. The liquid crystal display according to claim 4, wherein the driving circuit further comprises a plurality of voltage adjusters electrically connected with the corresponding drive chips for adjusting the corresponding set of Gamma voltages of each drive chip according to the distribution parameter.

6. A driving method for a liquid crystal display having a display panel and a driving circuit, the display panel having a common electrode, the method comprising:
providing a distribution parameter in accordance with a voltage distribution of a common electrode voltage on the common electrode; and
driving the display panel by the driving circuit according to the distribution parameter.

7. The method according to claim 6, wherein the step of providing the distribution parameter comprises measuring a voltage difference between two terminals of the common electrode so as to obtain the distribution parameter.

8. The method according to claim 6, wherein the step of driving the display panel comprises adjusting a plurality of gray level values according to the distribution parameter and driving the display panel according to the gray level values.

9. The method according to claim 6, wherein the step of driving the display panel including driving the display panel according to a plurality of sets of Gamma voltages generated according to the distribution parameter.
